(19) United States
(12) Patent Application Publication
(10) Pub. No.: US 2008/0044623 A1
(43) Pub. Date: Feb. 21, 2008

(54) PROBE CARD FOR TESTING IMAGING DEVICES, AND METHODS OF FABRICATING SAME

(76) Inventors: John Caldwell, Meridian, ID (US); Brett Crump, Boise, ID (US); Phil Byrd, Boise, ID (US)

Correspondence Address: WILLIAMS, MORGAN & AMERSON, 10333 RICHMOND, SUITE 1100, HOUSTON, TX, 77042, US

(21) Appl. No.: 11/465,897

(22) Filed: Aug. 21, 2006

(51) Int. Cl. B32B 3/10

(52) U.S. Cl. 428/137; 427/402; 427/240

(57) ABSTRACT

Disclosed is a probe card for imager devices, and methods of fabricating same. In one illustrative embodiment, a method of forming a probe card includes performing at least one etching process to define a plurality of light openings in a body of the probe card and forming a plurality of probe pins extending from the body. In another illustrative embodiment, a probe card that includes a body, at least one light opening formed in the body and at least one light conditioning device positioned within the at least one light opening is disclosed.

### BACKGROUND OF THE INVENTION

1. Field of the Invention

The present invention is generally directed to the field of testing integrated circuit devices, and, more particularly, to a probe card for testing imaging devices, and methods of fabricating same.

2Description of the Related Art

The microelectronics industry is highly competitive and microelectronic device manufacturers are very sensitive to quality and cost considerations. Most microelectronic device manufacturers are required to test the performance of each microelectronic device prior to shipping it to a customer. For example, microelectronic imagers are commonly tested by establishing temporary electrical connections between a test system and electrical contacts on each microelectronic imaging die while simultaneously exposing an image sensor on the device to light.

One way of establishing a temporary electrical connection between the test system and the contacts on a microelectronic component employs a probe card carrying a plurality of probe pins. The probe pins are typically either a length of wire (e.g., cantilevered wire probes) or a relatively complex spring-biased mechanism (e.g., pogo pins). The probe pins are connected to the probe card and arranged in a predetermined array for use with a specific microelectronic component configuration. For example, when testing a microelectronic imager with a conventional probe card (whether it be a cantilevered wire probe card, a pogo pin probe card or another design), the probe card is positioned proximate to the front side of the imaging die to be tested. The probe card and the imaging die are aligned with each other in an effort to precisely align each of the probe pins of the probe card with a corresponding electrical contact of the front side of the imaging die.

One problem with testing imaging dies at the wafer level is that it is difficult to expose an image sensor to light while simultaneously aligning the probe pins or the body of the probe card with the corresponding electrical contacts on the front side of the imaging die. For example, because the probe card is positioned over the image sensor to contact the front side bond-pads on the die, the probe card must have a plurality of holes or apertures through which light can pass. This limits wafer-level testing methods because of the physical constraints of probe card structures and the limited testing area available on the wafer. Further, the probe card and/or probe pins positioned proximate (but not over) the image sensor may also interfere with the light directed to the image sensor (e.g., shadowing, reflections). These limitations result in the ability to test only a fraction of the imaging dies on a wafer of imaging dies as compared to the number of other types of dies that can be tested in non-imaging applications (e.g., memory, processors, etc.). For example, only four CMOS imaging dies can be tested simultaneously on a wafer, compared to 128 DRAM dies using the same equipment. Accordingly, there is a need to improve the efficiency and throughput for testing imaging dies.

Traditional probe card structures for testing imaging devices are manufactured by a process employed in manufacturing printed circuit boards. The light openings formed in such traditional probe card structures are formed by traditional mechanical means, such as drilling. As imager devices become more sophisticated, the traditional structure of such probe cards can be a disadvantage as it relates to testing of advanced imager devices. Moreover, the prior art probe cards may limit their effectiveness or efficiency as it relates to future device generations, as such devices continue to be reduced in size.

The present invention is directed to a device and various methods that may solve, or at least reduce, some or all of the aforementioned problems.

### BRIEF DESCRIPTION OF THE DRAWINGS

The invention may be understood by reference to the following description taken in conjunction with the accompanying drawings, in which like reference numerals identify like elements, and in which:

FIG. 1 is an illustrative embodiment of a system in accordance with one aspect of the present invention;

FIGS. 2A-2E depict one illustrative embodiment of forming light openings for a probe card in accordance with one illustrative aspect of the present invention;

FIGS. 3A-3J depict one illustrative process flow for forming a probe card using micro-fabrication techniques and processes in accordance with one aspect of the present invention;

FIG. 4 depicts one embodiment of an illustrative imaging device comprising a plurality of light conditioning devices positioned within the light openings of the imaging device;

FIG. 5 depicts one embodiment of an illustrative imaging device comprising a plurality of electrical devices positioned within the light openings of the imaging device;

FIGS. 6A-6B depict yet another illustrative embodiment wherein one or more light conditioning deices and/or electrical devices are positioned within a device package that is positioned within a light opening of a probe card; and

FIG. 7 depicts another illustrative example wherein one or more of the light conditioning devices and/or electrical devices are formed integrally with the body of the card probe.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF THE INVENTION

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The present invention will now be described with reference to the attached figures. Various regions and structures of a probe card, an imager device, and an associated system for testing such devices are schematically depicted in the drawings. For purposes of clarity and explanation, the relative sizes of the various features depicted in the drawings may be exaggerated or reduced as compared to the size of those features or structures on real-world devices and systems. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be explicitly set forth in the specification in a definitional manner that directly and unequivocally provides the special definition for the term or phrase.

In general, the present invention is directed to a novel probe card for testing imager-type integrated circuit devices, methods of fabricating such probe cards, testing systems incorporating such probe cards, and testing imager devices using such probe cards. As will be recognized by those skilled in the art after a complete reading of the present application, the present invention may be employed with testing any of a variety of different microelectronic imager devices, e.g., CMOS-based imagers. Thus, the present invention should not be considered as limited to use with any particular type of imager device. Additionally, those skilled in the at will recognize that other terms may be employed to describe the general nature of the probe card described herein, e.g., test card, probe interposer, etc. For ease of reference, the term probe card will be used throughout the specification.

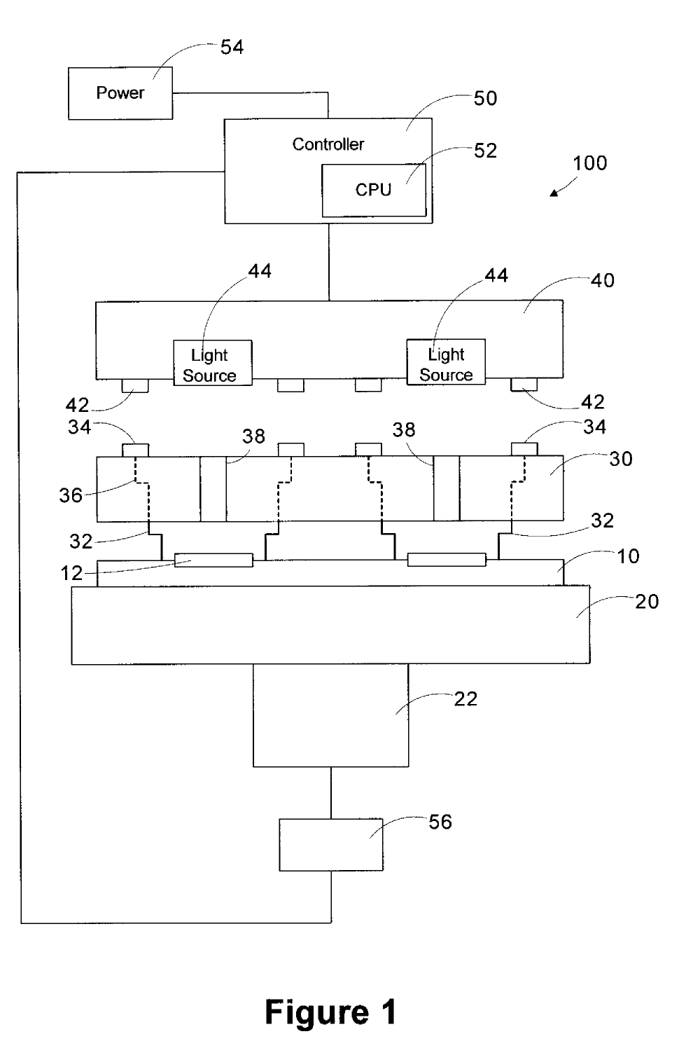

FIG. 1 schematically depicts a test system 100 in accordance with one illustrative embodiment of the present invention. Of course, all operational details of such a system are not shown or described herein so as to not obscure the present invention and because such details are well known to those skilled in the art. In general, the system 100 comprises a substrate 10 under test, a support structure 20, a probe card 30, a test head 40 and a controller 50.

The substrate 10 comprises a plurality of imager devices 12 that are to be testing using the test system 100. As indicated previously, the imager devices 12 are intended to be representative of any type of microelectronic imaging device that may be manufactured using any technique. In one illustrative embodiment, the imager device 12 is a CMOS imager device. Additionally, it should be understood that the schematically depicted imager device 12 may be designed to perform any desired function. For convenience, only two of the illustrative imager devices 12 are depicted on the substrate 10. In practice, hundreds of such imager devices 12 may be formed on a single substrate 10.

The support structure 20 is provided to position and support the substrate 10 during testing operations. The support structure 20 may be of traditional design. A schematically depicted actuator 22 may be employed to move the support structure 20 in the x-y direction so as to properly position the imager devices 12 at a desired location. The support structure 20 may also include an adjustable mechanism (not shown), e.g., screws, to finely control the vertical separation between the substrate 10 and the probe card 30.

The probe card 30 comprises a body or structure that includes a plurality of probe pins 32 and a plurality of test contacts 34 formed on the upper surface of the probe card 30. The probe pins 32 are electrically connected to the test contact 34 by electrical circuitry 36 formed within the probe card 30. The probe card 30 further comprises a light opening 38 to allow light from a light source to be projected onto the imager devices 12 positioned underneath the light opening 38. In the depicted embodiment, the probe pins 32 are depicted as cantilevered structures. However, after a complete reading of the present application, those skilled in the art will recognize that the probe pins 32 may be of any type or structure, e.g., pogo-pins, etc. Thus, the present invention should not be considered as limited to any particular type or structure of probe pin 32.

The test head 40 comprises a plurality of head contacts 42 and a plurality of light sources 44. The head contacts 42 are adapted to electrically contact the test contacts 34 to thereby establish an electrically conductive path between the test head 40 and the probe card 30. Individual light sources 44 are schematically depicted in FIG. 1. In practice, there may only be a single light source. Additionally, in the schematically depicted embodiment shown in FIG. 1, the light sources 44 are positioned within cavities defined in the test head 40. Those skilled in the art will recognize that such details are provided by way of example only and that such construction details may vary widely depending upon the particular test system employed. The light source 44 is adapted to generate any type of light necessary to irradiate the imager devices 12 to properly test such devices. In one illustrative embodiment, the light sources 44 generate a broad spectrum light when testing CMOS imager devices. Electrical connections to the head contacts 42 and the light sources 44 are provided by internal circuitry (not shown) formed within the test head 40 using traditional techniques.

The controller 50 comprises a programmable processor 52 that is positioned to control the basic operations of the system 100. The controller 50 also controls a power supply 54 that is used to supply power to the various components of the system 100. A separate actuator controller 56 may be employed to control movement of the support structure 20. In general, the controller 50 may be employed to activate the light sources 44 so as to irradiate the imager devices 12 under test, and to generate and transmit any desired test signals to the imager devices 12 via the probe pins 32. Such testing methods and protocols may vary depending upon the particular imager device 12 under test, all of which are well known to those skilled in the art. Additionally, the system 100 may be employed to test imager devices 12 one at a time or in groups.

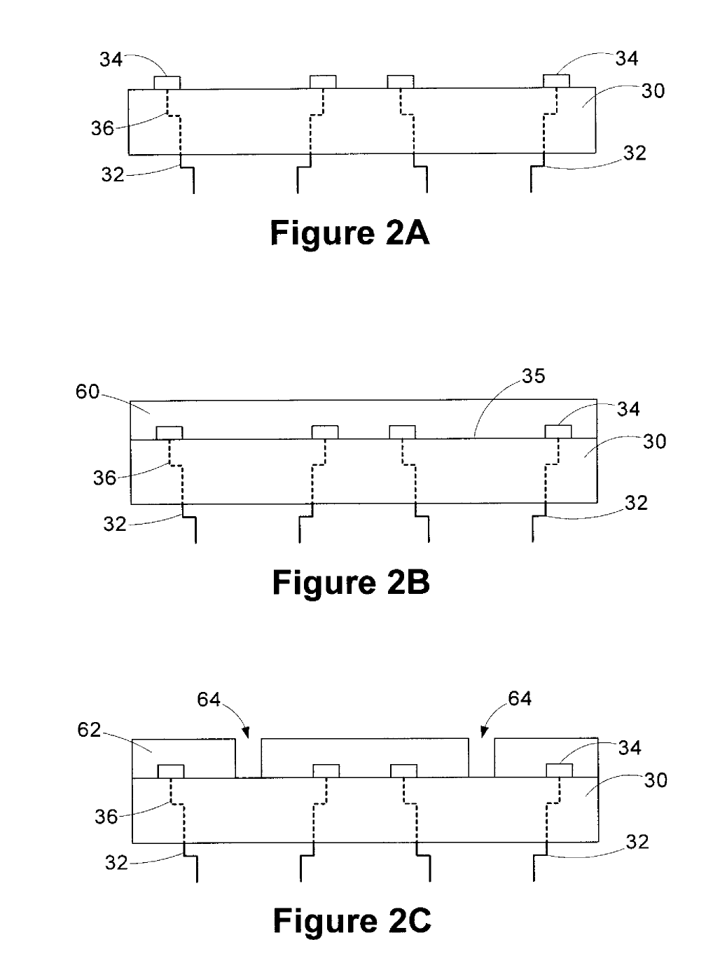

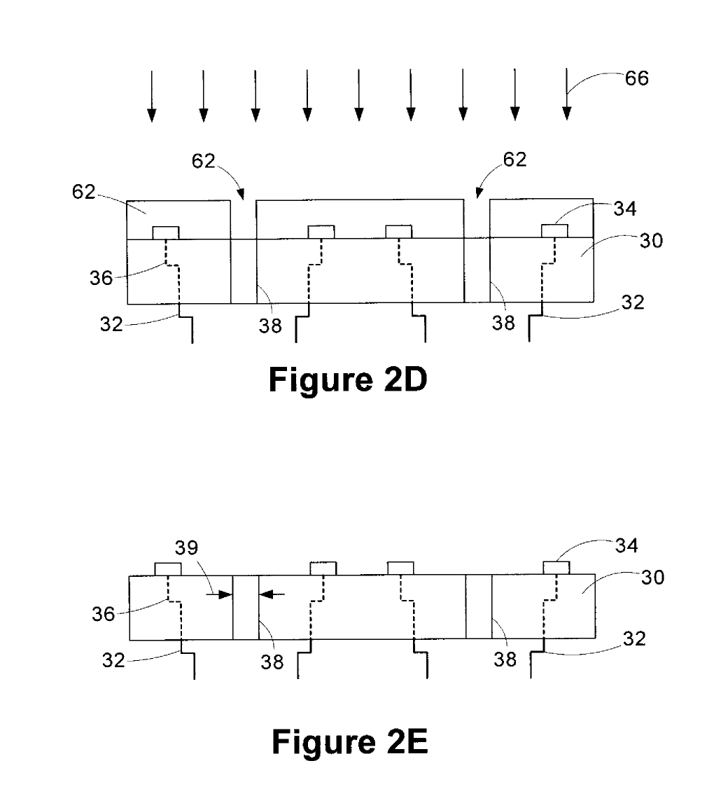

In accordance with one aspect of the present invention, the light openings 38 in the probe card 30 are formed using various micro-fabrication techniques and processes employed in manufacturing integrated circuits, such as the illustrative imager devices 12. One illustrative process flow for forming such a probe card 30 will now be described with reference to FIGS. 2A-2E.

FIG. 2A depicts an illustrative probe card 30 formed in accordance with traditional techniques. In the illustrative example depicted in FIG. 2A, the probe card 30 has been fabricated to the point wherein the probe pins 32 and test contacts 34 have been formed. Of course, the probe card 12 may be at any point of fabrication at which it is practical to form the light openings 38 by micro-fabrication techniques and processes. Thus, the stage of fabrication for the probe card 30 shown in FIG. 2A is provided by way of example only.

Next, as shown in FIG. 2B, a masking layer 60, e.g., photoresist, is formed above the top surface 35 of the probe card 30. Of course, if desired, the probe card 30 could be inverted and the masking layer 60 could be formed above the bottom surface 37 of the probe card 30.

As shown in FIG. 2C, the masking layer 60 is then patterned to define a patterned masking layer 62 having a plurality of openings 64 formed therein that corresponds to the light opening 38 that will be formed in the probe card 30. In the case where the masking layer 60 is comprised of a photoresist material, the patterned masking layer 62 may be formed using traditional photolithography techniques, e.g., exposure, develop, rinse, etc.

Next, as shown in FIG. 2D, one or more etching processes 66 are performed to define the light opening 38 in the probe card 30. Any type of etching process employed in manufacturing integrated circuit devices may be performed to define the light openings 38. In one illustrative embodiment, the etching process is an anisotropic dry etching process, such as a plasma-based etching process. Depending upon the materials of construction of the probe card 30, the etch chemistry of the etch process may have to be changed at various points during the etching process 66.

FIG. 2E depicts the probe card 30 with the light openings 38 formed therein using micro-fabrication photolithography and etching techniques. In contrast to prior art techniques for forming the openings 38, by using micro-fabrication technology, the size or critical dimension 39 of the light openings 38 may be very small and it may be very precisely controlled, e.g., sub-micron dimensions. Moreover, the shape of the light openings 38 may also vary, e.g., circular, rectangular, oval, etc. In one illustrative embodiment, the light openings 38 have a generally circular configuration. Of course, by using micro-fabrication technology, the size of the openings 38 may be as small as permitted by the limitations of the traditional photolithography and etching tools and techniques used in forming the openings 38.

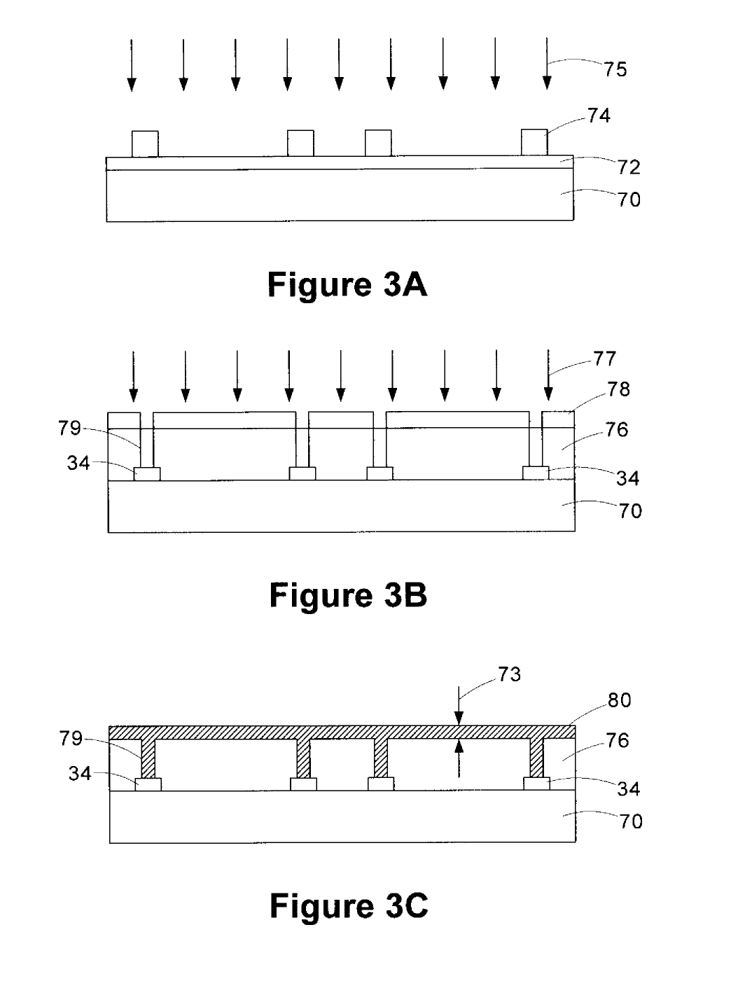

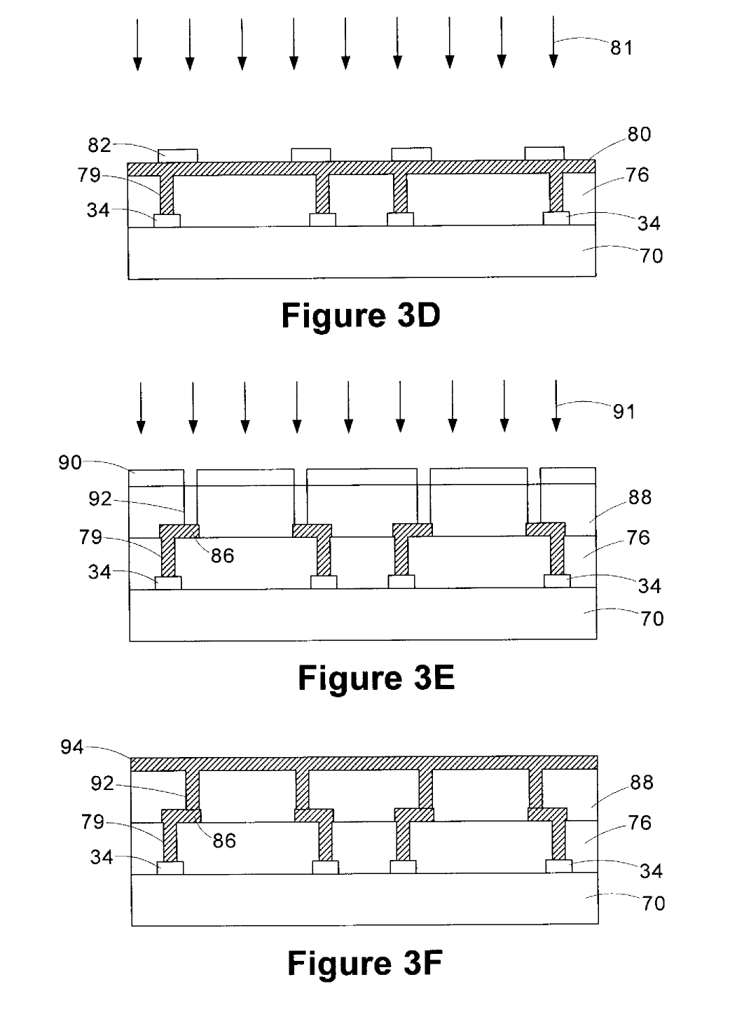

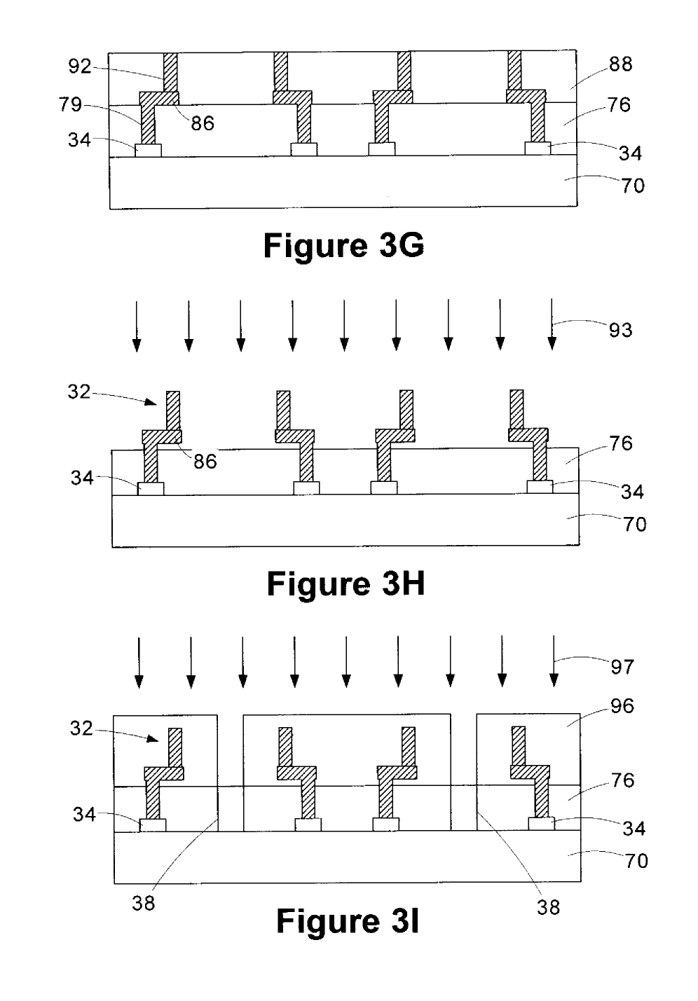

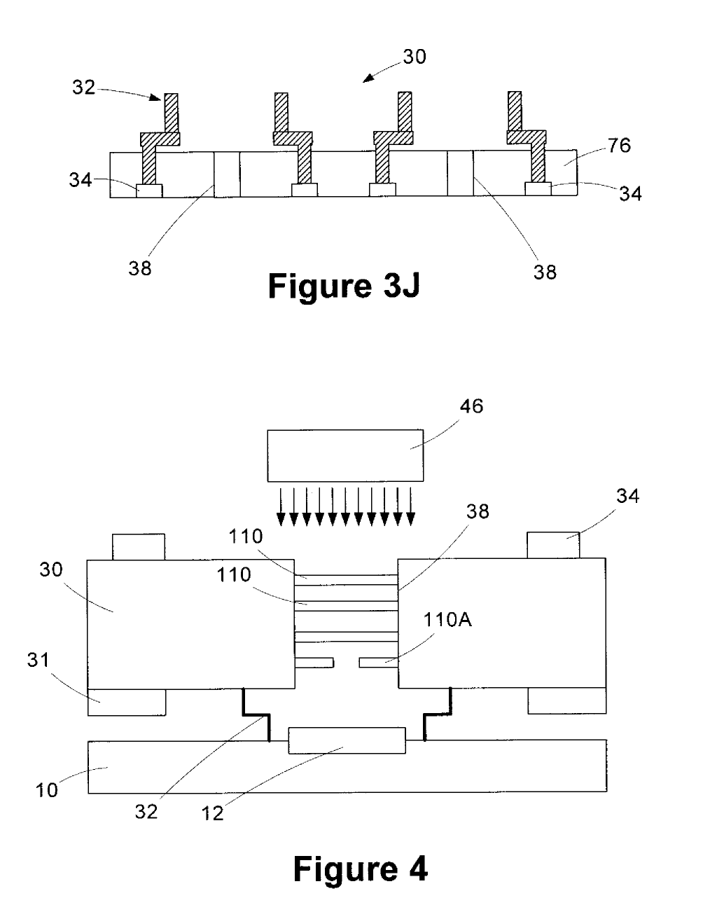

FIGS. 3A-3J depict another illustrative technique for forming a probe card 30 using micro-fabrication technology. In accordance with this aspect of the present invention, the probe card 30 may be manufactured layer-by-layer, structure-by-structure, using micro-fabrication techniques and processes, e.g., etching, deposition, photolithography, chemical mechanical planarization, etc. The etching and deposition processes may be plasma-based processes. By using such micro-fabrication techniques, the precision of probe card structures may be greatly enhanced to facilitate the testing of imager devices 12 as device dimensions continue to be reduced.

As shown in FIG. 3A, a sacrificial substrate or structure 70 is provided. A layer of conductive material 72, e.g., a metal, is deposited on the surface of the structure 70 using any of a variety of traditional micro-fabrication deposition tools and techniques, e.g., chemical vapor deposition (CVD) tools and techniques. Thereafter, a patterned masking layer 74 is formed above the layer 72. The patterned masking layer 74 may be comprised of a photoresist material, and it may be formed using traditional micro-fabrication photolithography tools and techniques, e.g., exposure, develop, strip, etc. An etching process 75 is then performed to etch the layer of conductive material 72. The etching process 75 may be a traditional anisotropic plasma-based etching process.

As shown in FIG. 3B, after the etching process 75 is performed, the masking layer 74 is removed, thereby leaving the electrical contacts 34 of the probe card 30. Then, a layer of insulating material 76, e.g., silicon dioxide, silicon nitride, is deposited using micro-fabrication deposition tools and techniques, e.g., a CVD deposition process. Another patterned masking layer 78, e.g., a photoresist material, may be formed using traditional micro-fabrication photolithography tools and techniques. An anisotropic etching process 77 is then performed to define openings 79 in the layer of insulating material 76.

Next, as shown in FIG. 3C, the masking layer 78 is removed, and a layer of conductive material 80, e.g., a metal, is deposited above the layer 76 and in the openings 79. The parameters of the deposition processed used to form the conductive material 80 may be controlled so as to determine the thickness 73 of the conductive material 80 above the surface of the layer 76. Then, as shown in FIG. 3D, a patterned masking layer 82, e.g., photoresist, is formed above the conductive layer 80. An anisotropic etching process 81 is then performed.

The etching process 81 results in patterning of the conductive layer 80 such that it includes extension region 86, as shown in FIG. 3E. Thereafter, another layer of insulating material 88 is deposited, and a patterned masking layer 90, e.g., photoresist, is formed above the layer 88. An anisotropic etch process 91 is performed to define openings 92 in the layer 88.

In FIG. 3F, the patterned masking layer 90 is removed and a layer of conductive material 94, e.g., a metal, is deposited above the layer of insulating material 88 and in the openings 92. Then, as shown in FIG. 3G, a planarization process, e.g., CMP, is performed to remove the excess conductive material 94 positioned outside of the openings 92.

In FIG. 3H, an isotropic etching process 93 is performed to remove the layer of insulating material 88 and portions of the layer 76. The isotropic etching process 93 results in the definition of the cantilevered probe pins 32 of the probe card 30.

Next, as indicated in FIG. 31, a patterned masking layer 96, e.g., photoresist, is then formed above the layer 76. An anisotropic etching process 97 is then performed to define the light openings 38 for the probe card 30. The sacrificial structure 70 may be removed by performing an etching process or a CMP process. The resulting probe card 30 is depicted in FIG. 3J in an inverted position.

After a complete reading of the present application, those skilled in the art will recognize that the process flow depicted in FIGS. 3A-3J is provided by way of example only, and that there are many different process flows that may be performed to form a probe card 30 using micro-fabrication technology and techniques. The process flow selected may also vary depending upon the particular application.

FIG. 4 schematically depicts another illustrative aspect of the present invention. As shown therein, one or more light conditioning devices 110 are positioned within the light opening 38 formed in the probe card 30. For simplicity, only a single light opening 38 is depicted in FIG. 4. The illustrative probe card 30 shown in FIG. 4 also comprises a plurality of mechanical standoffs 31 that aid in establishing or maintaining the appropriate vertical spacing between the probe card 30 and the substrate 10.

The light conditioning devices 110 described herein may be any type of device that changes, enhances or reduces any characteristic of the light as it passes through such a device. For example, the light conditioning device 110 may comprise a lens, a diffuser, an aperture, a filter, etc. The exact number, functionality and arrangement of such light conditioning devices 110 may vary depending upon the particular application and the desired characteristics of the light exiting the light opening 38 to irradiate the imager device 12. For example, as shown in FIG. 4, an aperture 110A is the final light conditioning device 110 positioned in the light opening 38. The aperture 110A may be used to concentrate the light that will irradiate the imager device 12.

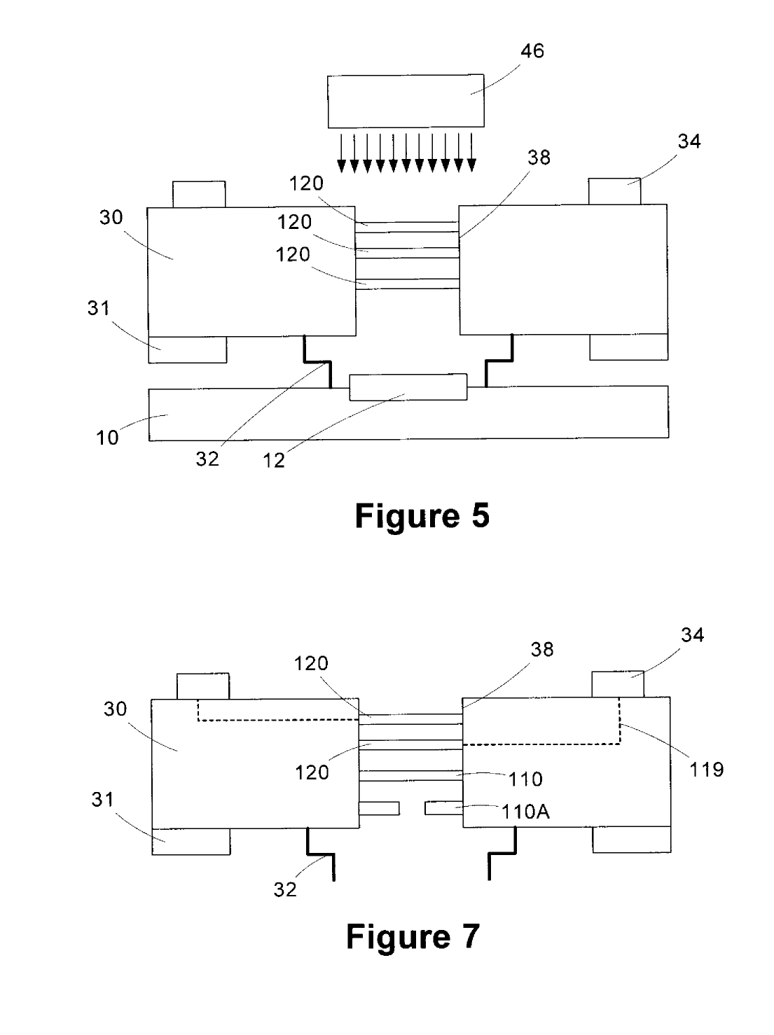

As shown in FIG. 5, in another illustrative aspect, one or more electrical devices 120 may be formed or positioned within the light opening 38. For example, such electrical devices 120 may be a light emitting diode (LED), a photo-sensitive transistor, any photosensitive electrical device, or any of a variety of other electrical devices known to those skilled in the art. Of course, if desired, the light opening 38 may have various combinations of light conditioning devices 110 and electrical devices 120 positioned therein to achieve a desired objective as it relates to testing of the imager device 12.

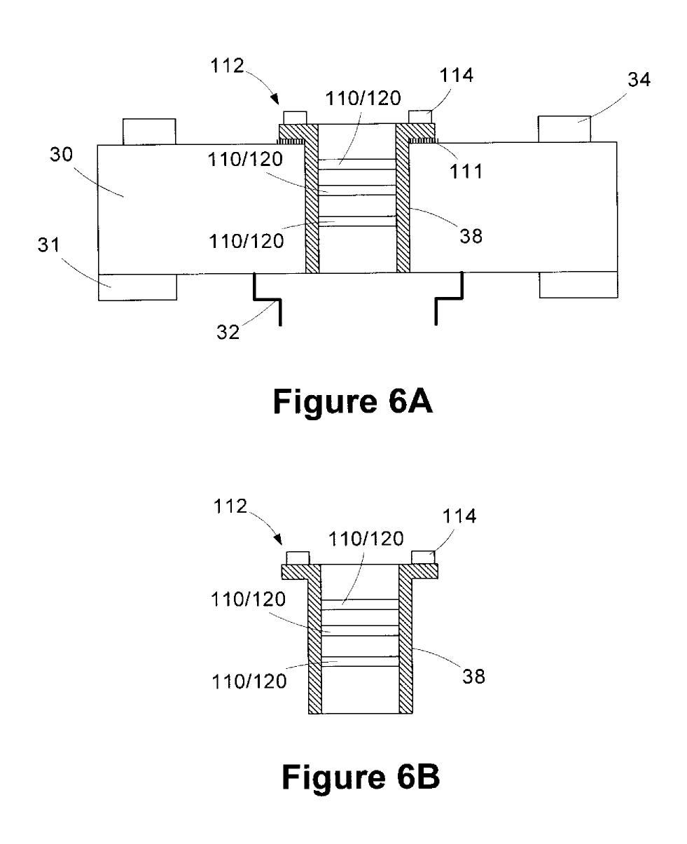

In accordance with another aspect of the present invention, the various light conditioning devices 110 and/or electrical devices 120 may be separately manufactured and positioned in a self-contained device package 112, as shown in FIGS. 6A-6B. To the extent electrical devices 120 are positioned in the device package 112, electrical contacts 114 may be provided to provide electrical power to such devices, if needed. If no electrical power is needed by the items 110/120 positioned in the device package 112, then the contacts 114 may be omitted. In the illustrative embodiment depicted in FIG. 6A, after the light opening 38 is formed, the device package 112 (shown separately in FIG. 6B) may be positioned in the opening 38 and secured to the probe card 30 by a variety of mechanical means, e.g., an adhesive material 111.

In accordance with yet another illustrative aspect of the present invention, the various light conditioning devices 110 and/or electrical devices 120 may be formed integrally with the probe card 30, i.e., they may be formed as part of the layer-by-layer manufacturing process using micro-fabrication techniques and processes described above with reference to FIGS. 3A-3J. FIG. 7 schematically depicts such an illustrative device wherein the electrical circuitry that comprises the electrical devices 120 is formed as part of the process flow used to form the probe card 30 using micro-fabrication techniques. In addition to the electrical circuitry of each of the devices 120, internal circuitry 119 may also be formed or defined within the probe card 30 as it is manufactured. The internal circuitry 119 may be conductively coupled to the test contacts 34 of the probe card 30 such that electrical power or signals may be provided to or received from the electrical devices 120 positioned within the light opening 38.

As shown in FIG. 7, one or more light conditioning devices 110 may also be formed or positioned in the opening 38 during the micro-fabrication process performed to form the probe card 30 using micro-fabrication technology. The exact process flow used to form the probe card 30 depicted in FIG. 7 will vary depending upon the particular application.

The particular embodiments disclosed above are illustrative only, as the invention may be modified and practiced in different but equivalent manners apparent to those skilled in the art having the benefit of the teachings herein. For example, the process steps set forth above may be performed in a different order. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A method of forming a probe card, comprising:
performing at least one etching process to define a plurality of light openings in a body of the probe card; and
forming a plurality of probe pins extending from the body.

2. The method of claim 1, wherein the body of the probe card is at least partially manufactured by performing a plurality of micro-fabrication process steps.

3. The method of claim 1, wherein the body of the probe card is at least partially manufactured by performing a plurality of deposition steps to form multiple layers of material and performing a plurality of etching processes to selectively remove portions of one or more of the layers of material.

4. The method of claim 1, wherein the at least one etching process comprises an anisotropic etching process.

5. The method of claim 1, wherein the at least one etching process is a plasma etching process.

6. The method of claim 1, wherein, prior to performing the at least one etching process, a masking layer is formed above the body, the masking layer having a plurality of openings formed therein that correspond to the plurality of light openings.

7. The method of claim 6, wherein the masking layer comprises a photoresist material that is applied by a spin-coating technique.

8. The method of claim 1, wherein the light openings have a sub-micron critical dimension.

9. A method of forming a probe card, comprising:
performing a plurality of microelectronic fabrication processes to form a body of the probe card.

10. The method of claim 9, wherein performing the plurality of microelectronic fabrication processes to form the body of the probe card comprises performing the plurality of microelectronic fabrication processes to form a plurality of probe pins extending from the body and a plurality of light openings extending through the body of the probe card

11. The method of claim 9, wherein the light openings have a sub-micron critical dimension.

12. The method of claim 9, wherein the microelectronic fabrication processes comprise at least one of an anisotropic etching process, an isotropic etching process, a chemical mechanical polishing process and a deposition process.

13. The method of claim 9, wherein performing the plurality of microelectronic fabrication processes to form the body of the probe card comprises performing a plurality of deposition steps to form a plurality of layers of material and performing one or more etching steps to remove selective portions of at least one of the layers of material.

14. The method of claim 9, wherein at least one of the microelectronic fabrication processes is a plasma-based process.

15. A probe card, comprising:
a body;
at least one light opening formed in the body; and
at least one light conditioning device positioned within the at least one light opening.

16. The probe card of claim 15, wherein the at least one light conditioning device comprises at least one of a lens, a diffuser, an aperture, and a filter.

17. The probe card of claim 15, further comprising at least one electrical device positioned within the light opening.

18. The probe card of claim 17, wherein the at least one electrical device comprises at least one of a light emitting diode, a photo-sensitive transistor and a photo-sensitive electrical device.

19. The probe card of claim 15, wherein the at least one light conditioning device is part of a separate device package positioned within the light opening.

20. The probe card of claim 15, wherein the at least one conditioning device is integrally formed with the body of the probe card.

21. The probe card of claim 15, wherein the probe card is positioned adjacent a test head of a test system.

22. A probe card, comprising:
a body;
at least one light opening formed in the body; and
at least one electrical device positioned within the at least one light opening.

23. The probe card of claim 22, wherein the at least one electrical device comprises at least one of a light emitting diode, a photo-sensitive transistor and a photosensitive electrical device.

24. The probe card of claim 22, wherein the at least one electrical device is part of a separate device package positioned within the light opening.

25. The probe card of claim 22, wherein the at least one electrical device is integrally formed with the body of the probe card.

26. The probe card of claim 22, wherein the probe card is positioned adjacent a test head of a test system.

27. A method of forming a probe card, comprising:
forming a light opening in a body of the probe card; and
positioning at least one of a light conditioning device and at least one electrical device within the light opening.

28. The method of claim 27, wherein at least one of the light conditioning devices comprises at least one of a lens, a diffuser, an aperture and a filter.

29. The method of claim 27, wherein the at least one electrical device comprises at least one of a light emitting diode, a photo-sensitive transistor and a photo-sensitive electrical device.

30. The method of claim 27, wherein at least one light conditioning device and at least one electrical device are positioned in the light opening.

31. The method of claim 27, wherein the light opening has a sub-micron critical dimension.

32. The method of claim 27, wherein the at least one light conditioning device and the at least one electrical device are contained in a separate package that is positioned in the light opening.

33. The method of claim 32, further comprising securing said package to the body of the probe card.

34. A method of forming a probe card, comprising:
forming a light opening in a body of a probe card; and
integrally forming at least one of a light conditioning device and an electrical device with the body, wherein the at least one light conditioning device and the electrical device are positioned within the light opening.

35. The method of claim 34, wherein the light opening has a sub-micron critical dimension.

36. The method of claim 34, wherein the at least one light conditioning device and the at least one electrical device are defined by performing at least one microelectronic fabrication process.

37. The method of claim 34, wherein at least one of the light conditioning devices comprises at least one of a lens, a diffuser, an aperture and a filter.

38. The method of claim 34, wherein the at least one electrical device comprises at least one of a light emitting diode, a photo-sensitive transistor and a photo-sensitive electrical device.

39. The method of claim 34, wherein at least one light conditioning device and at least one electrical device are positioned in the light opening.

40. The method of claim 34, wherein the at least one light conditioning device and the at least one electrical device are contained in a separate package that is positioned in the light opening.

41. The method of claim 40, further comprising securing said package to the body of the probe card.
